(19) United States
(12) Patent Application Publication
(10) Pub. No.: US 2018/0329983 A1
(43) Pub. Date: Nov. 15, 2018

(54) SEARCH APPARATUS AND SEARCH METHOD

(71) Applicant: FUJITSU LIMITED, Kawasaki-shi (JP)

(72) Inventors: Takamichi Toda, Kawasaki (JP); Ryuichi Takagi, Nakano (JP)

(73) Assignee: FUJITSU LIMITED, Kawasaki-shi (JP)

(21) Appl. No.: 15/968,022

(22) Filed: May 1, 2018

(30) Foreign Application Priority Data
May 15, 2017 (JP) 2017-096828

(51) Int. Cl. G06F 17/30; G06N 5/02

(52) U.S. Cl. CPC G06F 17/30654; G06N 99/005; G06N 5/02; G06F 17/30675

(57) ABSTRACT

A search apparatus includes a memory and a processor configured to receive question information, perform evaluation of the question information, and when a result of the evaluation satisfies a condition, output answer information extracted by searching based on the question information, the answer information being extracted from among a plurality of pieces of answer information stored in the memory, and, when the result of the evaluation does not satisfy the condition, output information for prompting input of additional information to specify detail of the question information.

### CROSS-REFERENCE TO RELATED APPLICATION

This application is based upon and claims the benefit of priority of the prior Japanese Patent Application No. 2017-96828, filed on May 15, 2017, the entire contents of which are incorporated herein by reference.

### FIELD

The embodiments discussed herein are related to a search technique and a learning technique.

### BACKGROUND

The related art provides a case search system. In the case search system, a past case database accumulating past similar cases in which past questions are associated with their answers is searched based on a question received from a user, and answers are obtained based on similar cases about the question. In addition, a system has been introduced. In the system, a chatbot, an interactive user interface, collaborates with a case search system, and similar cases for a question are searched for in real time to provide answers to a user.

Japanese Laid-open Patent Publication No. 2013-206177 describes the related art.

### SUMMARY

According to an aspect of the invention, a search apparatus includes a memory and a processor configured to receive question information, perform evaluation of the question information, and when a result of the evaluation satisfies a condition, output answer information extracted by searching based on the question information, the answer information being extracted from among a plurality of pieces of answer information stored in the memory, and, when the result of the evaluation does not satisfy the condition, output information for prompting input of additional information to specify detail of the question information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary case search apparatus according to a first embodiment;

FIGS. 2A and 2B are schematic diagrams illustrating exemplary training data of an asking-back necessity learning model according to the first embodiment;

FIG. 3 is a schematic diagram illustrating exemplary asking-back necessity learning based on past response cases according to the first embodiment;

FIG. 4 is a diagram an exemplary asked-back content table according to the first embodiment;

FIG. 5 is a flowchart of an exemplary asking-back necessity determination process according to the first embodiment;

FIG. 6 is a diagram illustrating an exemplary case search apparatus according to a second embodiment;

FIG. 7 is a schematic diagram illustrating exemplary training data of an asking-back category learning model according to the second embodiment;

FIG. 8 is a diagram illustrating an exemplary correspondence table between categories and expected answers according to the second embodiment;

FIG. 9 is a schematic diagram illustrating exemplary changes in the order of search results obtained when each expected answer is added to a question, according to the second embodiment;

FIG. 10 is a diagram illustrating an exemplary asked-back content table according to the second embodiment;

FIG. 11 is a flowchart of an exemplary labeling process according to the second embodiment; and

FIG. 12 is a diagram illustrating a computer executing a case search program.

### DESCRIPTION OF EMBODIMENTS

The related art has the following problem. In the case where a question received from a user has insufficient information, even when a past case database is searched based on the question from the user, an appropriate answer based on similar cases about the question fails to be provided to the user, resulting in low accuracy in the case searching.

Embodiments of a determination program, a determination method, and a determination apparatus according to the disclosed technique will be described in detail below based on the drawings. However, the embodiments described below do not limit the present disclosure. The embodiments may be combined appropriately as long as the combined processes are not contradictory.

### First Embodiment

### A Case Search Apparatus According to the First Embodiment

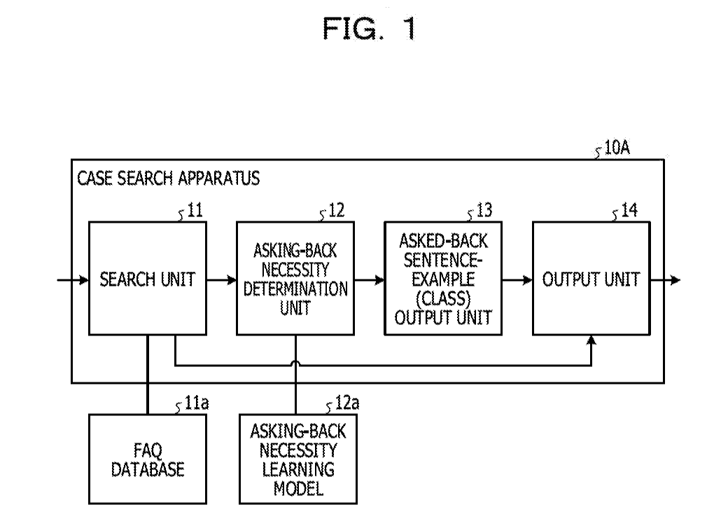

FIG. 1 is a diagram illustrating an exemplary case search apparatus according to a first embodiment. A case search apparatus 10A according to the first embodiment is a server including a processing device such as a central processing unit (CPU). Information is input/output from/to the case search apparatus 10A, for example, through the interface of a chatbot displayed on a client terminal (not illustrated) connected to the case search apparatus 10A over a given network. However, this is not limiting. Information may be input/output from/to the case search apparatus 10A through voice. The client terminal (not illustrated) is, for example, a personal computer, a smartphone, or a tablet.

In frequently asked questions (FAQ) searching performed by using, as an input, a question (or an inquiry) received from a user, in the case where an answer to the question which is obtained by referring to an asking-back necessity learning model is appropriate, the case search apparatus 10A outputs the FAQ search result. The case in which an answer to a question is appropriate indicates, for example, the case in which the answer is labeled as a “positive example” with a probability of 70% or more. In contrast, in FAQ searching performed by using, as an input, a question received from a user, in the case where an answer to the question which is obtained by referring to the asking-back necessity learning model is not appropriate, the case search apparatus 10A infers asked-back content about which the user is to be asked back. Then, the case search apparatus 10A outputs the inferred asked-back content. The case in which an answer to a question is not appropriate indicates, for example, the case in which the answer is labeled as a “positive example” with a probability less than 70%. The probability which is used in the determination as to whether or not an answer to a question is appropriate and with which the answer is to be labeled as a “positive example” may be changed appropriately.

The case search apparatus 10A includes a search unit 11, an asking-back necessity determination unit 12, an asked-back sentence-example (class) output unit 13, and an output unit 14. The search unit 11 is connected to a FAQ database 11a. The FAQ database 11a accumulates questions, each of which is associated with one or more answers, based on past response cases. In the FAQ database 11a, each question and its answer(s) are managed by using a unique ID. In the FAQ database 11a, the content about each question is associated, for management, with a corresponding question ID, and the content (answer content) of each response case is associated, for management, with a corresponding answer ID.

Based on a question received from a user, the search unit 11 searches the FAQ database 11a, and obtains a result of search which includes one or more answers to the question. In the result of search, the answers corresponding to the question are ranked by using certainty factors indicating the degrees of satisfaction of the input question. A certainty factor is an exemplary evaluation index indicating how much a case search result is suitable as an answer to the question. The search unit 11 outputs, to the asking-back necessity determination unit 12, a question received, from the user. Further, the search unit 11 outputs, to the output unit 14, the search results obtained by referring to the FAQ database 11a.

The Asking-Back Necessity Determination Unit

The asking-back necessity determination unit 12 is connected to an asking-back necessity learning model 12a. The asking-back necessity learning model 12a is an exemplary binary classification learning unit. The expression “binary” indicates “asking-back” and “no asking-back”. The asking-back necessity determination unit 12 refers to the asking-back necessity learning model 12a based on the question received from the search unit 11, and determines whether “asking-back” or “no asking-back” is to be performed. That is, when the question received from the search unit 11 is labeled as a “positive example” with a given probability (for example, 70%) or more, the asking-back necessity determination unit 12 determines that “no asking-back” is to be performed. In contrast, when the question received from the search unit 11 is labeled as a “positive example” with a probability less than the given probability (for example, 70%), the asking-back necessity determination unit 12 determines that “asking-back” is to be performed. The given probability may be changed appropriately.

When the asking-back necessity determination unit 12 determines that “asking-back” is to be performed, the asking-back necessity determination unit 12 instructs the output unit 14 to output, as an output from the case search apparatus 10A, “asked-back content” determined as described below. In contrast, when the asking-back necessity determination unit 12 determines that “no asking-back” is to be performed, the asking-back necessity determination unit 12 instructs the output unit 14 to output, as an output from the case search apparatus 10A the result obtained by the search unit 11 searching the FAQ database 11a.

Training Data of the Asking-Back Necessity Learning Model

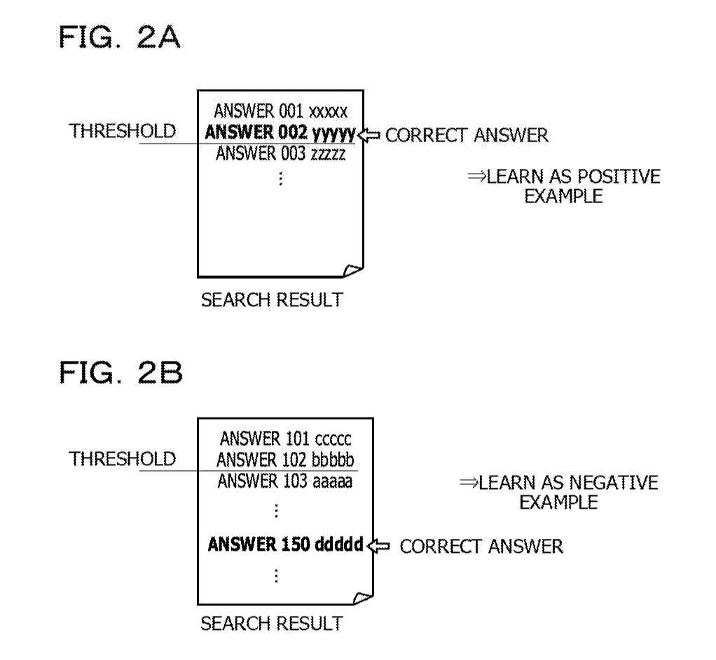

Training data of the asking-back necessity learning model 12a will be described. In the first embodiment, the asking-back necessity learning model 12a has learned in advance. FIGS. 2A and 2B are schematic diagrams illustrating exemplary training data of the asking-back necessity determination learning model according to the first embodiment. As illustrated in FIG. 2A, for example, in the search results obtained by the search unit 11, when the “correct answer” is ranked as the first or second rank of the search results, the asking-back necessity learning model 12a learns the “correct answer” as a “positive example”. As illustrated in FIG. 2B, for example, in the search results obtained by the search unit 11, when the “correct answer” is ranked lower than the second rank of the search results, the asking-back necessity learning model 12a learns the “correct answer” as a “negative example”. The expression “the second rank of the search results” indicates a threshold for the determination as to whether or not the “correct answer” is to be learned as a “positive example” in the search results obtained by the search unit 11. The expression indicates an exemplary learning value used when the asking-back necessity learning model 12a learns.

For example, in FIG. 2A, the “answer 002 yyyyy” which is the “correct answer” is an answer ranked as being placed at the threshold or higher. Therefore, the “answer 002 yyyyy” is labeled as a “positive example” and is learned by the asking-back necessity learning model 12a. In contrast, in FIG. 26, the “answer 150 ddddd” which is the “correct answer” is an answer ranked as being placed lower than the threshold. Therefore, the “answer 150 ddddd” is labeled as a “negative example” and is learned by the asking-back necessity learning model 12a.

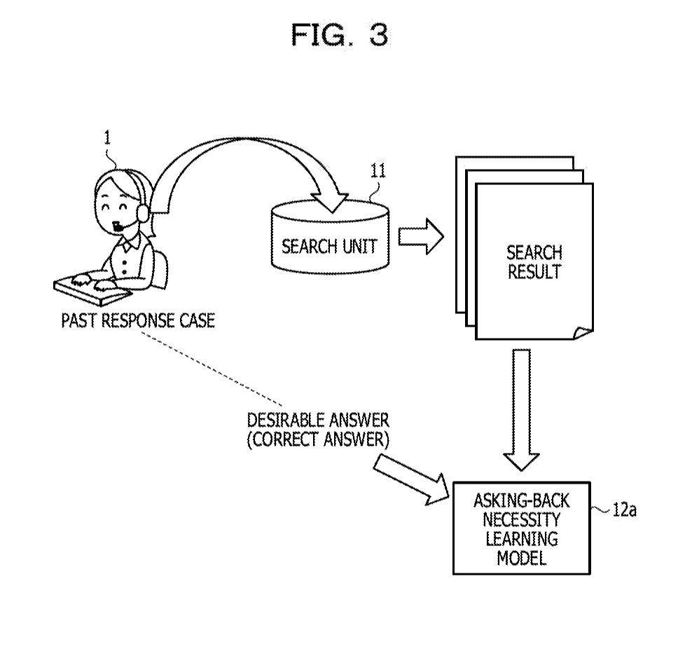

FIG. 3 is a schematic diagram illustrating exemplary asking-back necessity learning based on past response cases according to the first embodiment. As illustrated in FIG. 3, an operator 1 inputs a past question and its response case (answer) to the search unit 11. Based on the past question received from the operator 1, the search unit 11 generates search results. In contrast, the operator 1 associates a “desirable answer (correct answer)” to the past question with the search results obtained by the search unit 11 so as to input the association to the asking-back necessity learning model 12a.

The “desirable answer (correct answer)” to the question is labeled as a “positive example” or a “negative example” based on the ranking of the results obtained by the search unit 11 searching by using the question, and is learned by the asking-back necessity learning model 12a. That is, the asking-back necessity learning model 12a reads a large amount of data about labeling as a “positive example” or a “negative example” for each question, for example, through deep learning. Thus, the asking-back necessity learning model 12a learns each probability with which the corresponding question is labeled as a “positive example” or a “negative example”.

The Asked-Back Sentence-Example (Class) Output Unit

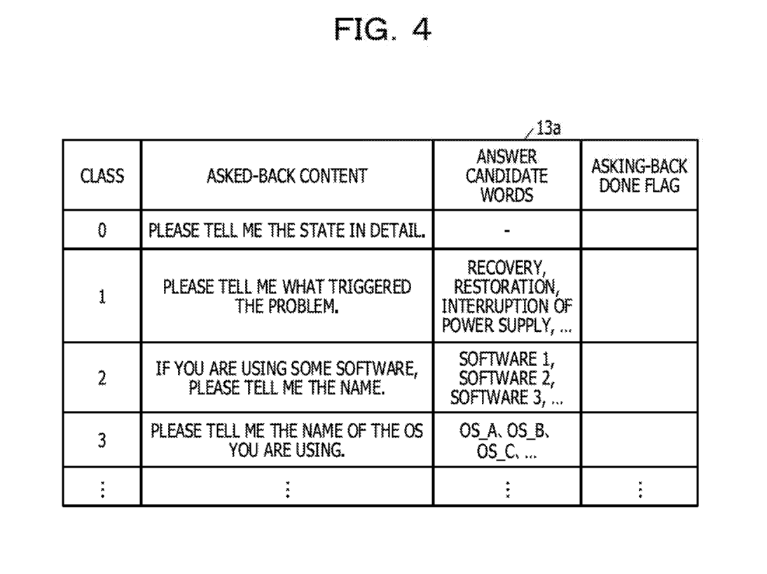

The asked-back sentence-example (class) output unit 13 includes, for example, an asked-back content table 13a (see FIG. 4). The asked-back sentence-example (class) output unit 13 also includes an inverse document frequency (IDF) dictionary (not illustrated). The IDF dictionary included in the asked-back sentence-example (class) output unit 13 is data in which words, such nouns or verbs, are associated with corresponding IDF values.

FIG. 4 is a diagram illustrating an exemplary asked-back content table according to the first embodiment. The asked-back content table 13a has items of the “class”, the “asked-back content”, the “answer candidate words”, and the “asking-back done flag”. The “class” indicates identification information for identifying the “asked-back content”. The “asked-back content” indicates the content that is actually asked back through the interface of a chatbot to the user who has asked the question. Each word in the “answer candidate words” is associated with a corresponding IDF value in the IDF dictionary included in the asked-back sentence-example (class) output unit 13.

When the asking-back necessity determination unit 12 determines that “asking-back” is to be performed, the asked-back sentence-example (class) output unit 13 extracts, from the words in the IDF dictionary, a word which is not included in the question received from the user, and which has the highest IDF value. Then, the asked-back sentence-example (class) output unit 13 specifies, for output, the “asked-back content” of a “class” in which the extracted word having the highest IDF value is included as the “answer candidate words”.

For example, in FIG. 4, assume that a question from a user is “I want to create a recovery disk.” and that the asking-back necessity determination unit 12 has determined that an asking-back operation is to be performed. At that time, assume that “OS_B” is a word having the highest IDF value in the IDF dictionary. The “asked-back content”, “May I ask which OS you are using?”, of a “class” of “3” including “OS_B” as the “answer candidate words” is selected as an asked-back sentence. Then, the selected asked-back sentence, “May I ask which OS you are using?”, is output as an output from the case search apparatus 10A.

The asked-back sentence-example (class) output unit 13 sets “ON” to the “asking-back done flag” for the “asked-back content” that has been selected, so that the selected “asked-back content” will not be selected again. In addition, the asked-back sentence-example (class) output unit 13 sets the upper limit (for example, three) to the number of asking-back operations that are to be performed. For example, when the asking-back necessity determination unit 12 determines that “asking-back” is to be performed even after the number of asking-back operations reaches the upper limit, the asked-back sentence-example (class) output unit 13 selects, for output, the “asked-back content”, “Please tell me the state in detail.”, of a “class” of “0”. Then, the asked-back sentence-example (class) output unit 13 ends repetition of the asking-back operation. At that time, for example, the case search apparatus 10A may inform the user of a call center number, may automatically inform a call center, or may output an alert to an upper-level apparatus (for example, a user support system using a chatbot) of the case search apparatus 10A.

### An Asking-Back Necessity Determination Process According to the First Embodiment

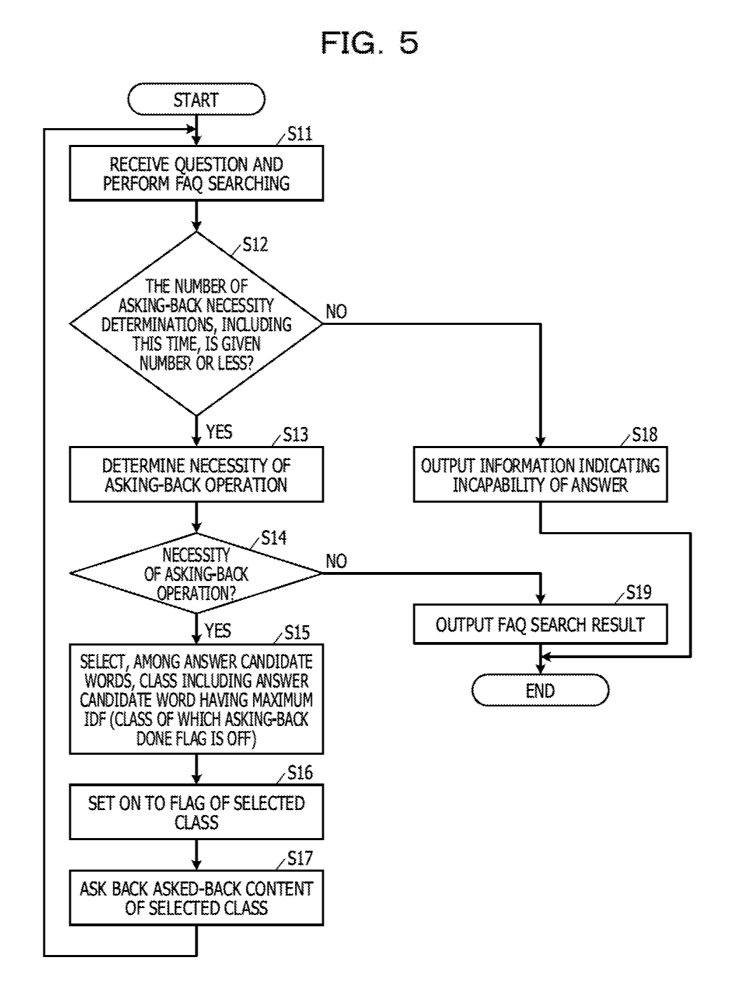

FIG. 5 is a flowchart of an exemplary asking-back necessity determination process according to the first embodiment. The processing device of the case search apparatus 10A performs the asking-back necessity determination process according to the first embodiment. In step S11, the search unit 11 receives a question from a user, performs a FAQ search using the received question, and obtains search results. In step S12, the asking-back necessity determination unit 12 determines whether or not the number of asking-back necessity determinations, including this time, is a given number or less. If the number of asking-back necessity determinations, including this time, is the given number or less (Yes in step S12), the asking-back necessity determination unit 12 causes the process to proceed to step S13. In contrast, if the number of asking-back necessity determinations, including this time, is greater than the given number (No in step S12), the asking-back necessity determination unit 12 causes the process to proceed to step S18.

In step S13, the asking-back necessity determination unit 12 refers to the asking-back necessity learning model 12a by using, as an input, the question received from the search unit 11, and determines whether or not the question is a “positive example” with the given probability or more. In step S14, based on the reference to the asking-back necessity learning model 12a using, as an input, the question received from the search unit 11, the asking-back necessity determination unit 12 determines whether or not the question has “necessity of an asking-back operation” indicated by a “positive example” with a probability less than the given probability. If the question has “necessity of an asking-back operation” (Yes in step S14), the asking-back necessity determination unit 12 causes the process to proceed to step S15. In contrast, if the question does not have “necessity of an asking-back operation” (No in step S14), the asking-back necessity determination unit 12 causes the process to proceed to step S19.

In step S15, the asked-back sentence-example (class) output unit 13 selects, among the answer candidate words, a class including an answer candidate word having the maximum IDF (a class of which the asking-back done flag is OFF). In step S16, the asked-back sentence-example (class) output unit 13 sets ON to the asking-back done flag of the class selected in step S15. In step S17, the asked-back sentence-example (class) output unit 13 outputs the asked-back content so that the asked-back content of the class selected in step S15 is asked back. Upon completion of step S17, the case search apparatus 10A causes the process to proceed to step S11.

In contrast, in step S18, the asked-back sentence-example (class) output unit 13 outputs, to the output unit 14, information indicating that an answer is not capable of being given. At that time, the asked-back sentence-example (class) output unit 13 may output, to the output unit 14, the “asked-back content” of a “class” of “0”. In step S19, the output unit 14 outputs the FAQ search result obtained by the search unit 11 in step S11. Upon completion of step S18 or step S19, the case search apparatus 10A ends the asking-back necessity determination process according to the first embodiment.

In the first embodiment, for example, the search unit 11 receives question information. In addition, for example, the asking-back necessity determination unit 12 evaluates the received question information. The evaluation indicates an evaluation as to whether or not an asking-back operation is to be performed. In addition, for example, the asked-back sentence-example (class) output unit 13 and the output unit 14 determine, based on the evaluation result, which is to be performed between the following operations: an operation in which pieces of question information selected in accordance with the received question information from among the multiple pieces of question information stored in a storage unit are output in a selectable manner; and an operation in which information for prompting addition of information for specifying the received question information is output. The operation in which pieces of question information selected in accordance with the received question information from among the multiple pieces of question information are output a selectable manner indicates an operation in which, for example, a given number of top FAQ search results for the received question information are displayed in a selectable manner.

### Second Embodiment

### A Case Search Apparatus According to the Second Embodiment

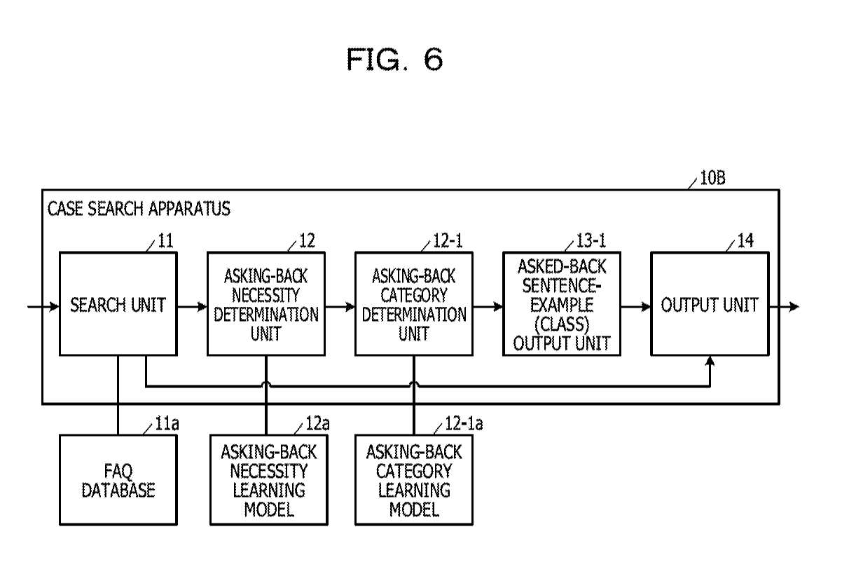

FIG. 6 is a diagram illustrating an exemplary case search apparatus according to a second embodiment. Only differences between the first embodiment and the second embodiment will be described. Compared with the case search apparatus 10A according to the first embodiment, a case search apparatus 10B according to the second embodiment further includes an asking-back category determination unit 12-1, and also includes an asked-back sentence-example (class) output unit 13-1 instead of the asked-back sentence-example (class) output unit 13. In the second embodiment, the asking-back necessity determination unit 12 outputs, to the asking-back category determination unit 12-1, a question for which it is determined that an asking-back operation is to be performed.

The Asking-Back Category Determination Unit and Training Data of an Asking-Back Category Learning Model

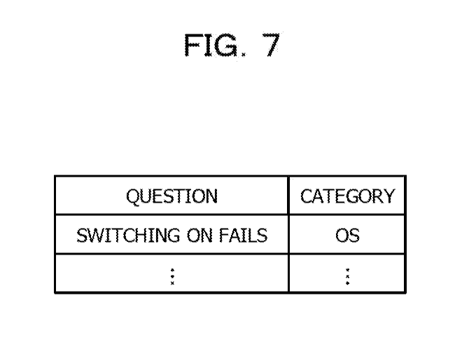

The asking-back category determination unit 12-1 is connected to an asking-back category learning model 12-1a. In the second embodiment, the asking-back necessity learning model 12a and the asking-back category learning model 12-1a have learned in advance. FIG. 7 is a schematic diagram illustrating exemplary training data of the asking-back category learning model according to the second embodiment. As illustrated in FIG. 7, the training data of the asking-back category learning model includes items of the “question” and the “category”. The “question” indicates a question from a user. The “category” indicates a label for classifying the “question”. For example, as illustrated in the training data of the asking-back category learning model in FIG. 7, a “question” of “Switching on fails” which is a negative example is associated with a “category” of “OS”.

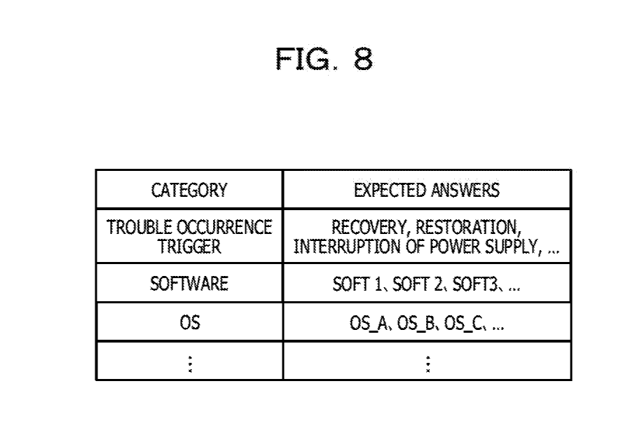

The training data of the asking-back category learning model illustrated in FIG. 7 is generated as follows. FIG. 8 is a diagram illustrating an exemplary correspondence table between categories and expected answers according to the second embodiment. The correspondence table between categories and expected answers stores the “category” and the “expected answers” in association with each other. The “category” indicates a label given to words included in the “expected answers”. The “expected answers” are classified by using the “category”. Examples of the “category” include the “trouble occurrence trigger”, the “software”, and the “OS”. For example, when the category is the “trouble occurrence trigger”, the “expected answers” are a “recovery”, a “restoration”, an “interruption of power supply” and so on. For example, when the “category” is the “software”, the “expected answers” are “Software 1”, “Software 2”, “Software 3” and so on. For example, when the “category” is the “OS”, the “expected answers” are “OS_A”, “OS_B”, “OS_C” and so on.

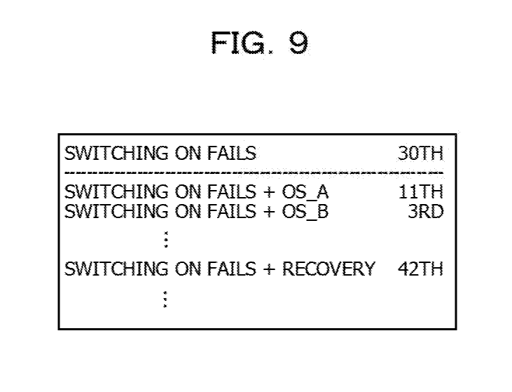

FIG. 9 is a schematic diagram illustrating exemplary changes in the order of search results obtained when each expected answer is added to a question in the second embodiment. The search unit 11 adds each word included in the “expected answers” in the correspondence table between categories and expected answers illustrating in FIG. 8, to a negative example question for which it is determined that “asking-back” is to be performed and which is output from the asking-back necessity determination unit 12. The search unit 11 searches the FAQ database 11a by using the negative example question to which each word included in the “expected answers” has been added, and obtains a search result again. The search unit 11 recognizes the change in ranking obtained at that time.

In the example, in FIG. 9, the original negative example “question” is “Switching on fails”, and the ranking in the search results is 30th. When the word “OS_A” is added and “Switching on fails+OS_A” is used, the ranking increases from 30th, which is obtained when only “Switching on fails” is used, to 11th. When the word “OS_B” is added and “Switching on fails+OS_B” is used, the ranking increases from 30th, which is obtained when only “Switching on fails” is used, to 3rd. In contrast, when the word “recovery” is added and “Switching on fails+recovery” is used, the ranking decreases from 30th, which is obtained when only “Switching on fails” is used, to 42th. Accordingly, a word which causes the largest increase in ranking in the search results obtained by the search unit 11 by adding the word to “Switching on fails” is “OS_B”. The correspondence table between categories and expected answers illustrated in FIG. 8 is referred to, and it may be determined that the “category” for the word causing the ranking to increase is the “OS”.

Thus, to each negative example “question”, the “category” of a word causing the ranking to increase is labeled. A large amount of training data in which, to each negative example “question”, the “category” of a word causing the ranking to increase is labeled is accumulated through machine learning. Then, for example, training data is generated in which, to a certain negative example “question”, a “category” of the “trouble occurrence trigger” is labeled with a probability of 60%, a “category” of the “software” is labeled with a probability of 30%, and a “category” of the “OS” is labeled with a probability of 10%. As a larger amount of training data like this is learned, the accuracy as the machine learning model is improved, enabling an appropriate question based on the “category” to be asked back.

Labeling using the “category” of a word causing the ranking to increase is not limited to labeling using the “category” of a word which causes the maximum ranking increase through addition of the word and which is included in the “expected answers”. For example, labeling using the “category” of a word causing the ranking to increase may be labeling using a “category” having the maximum statistical value, such as the total or the average in the “category”, of the ranking increases of the words included in the “expected answers”. The ranking increases are caused by addition of the words.

The asking-back category determination unit 12-1 determines that a “category” satisfying the following conditions is to be a category given to an input negative example “question”. The conditions are that, among the categories labeled to the same “question”, the category is labeled to the negative example “question” with the maximum probability and that the maximum probability is equal to or more than a given probability (for example, 70%). The given probability may be changed appropriately.

The Asked-Back Sentence-Example (Class) Output Unit

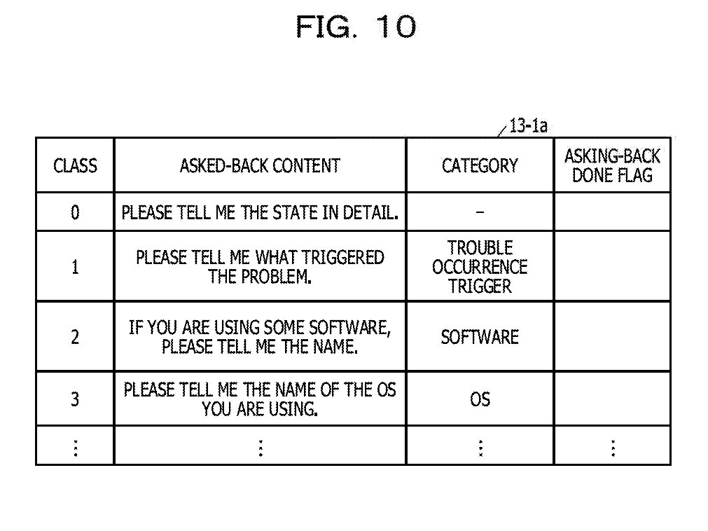

The asked-back sentence-example (class) output unit 13-1 includes an asked-back content table 13-1a (see FIG. 10). FIG. 10 is a diagram illustrating an exemplary asked-back content table according to the second embodiment. As illustrated in FIG. 10, compared with the asked-back content table 13a according to the first embodiment, the asked-back content table 13-1a has the “category” item instead of the “answer candidate words” item. Other than this, the asked-back content table 13-1a is substantially the same as the asked-back content table 13a. The asked-back sentence-example (class) output unit 13-1 refers to the asked-back content table 13-1a based on the asking-back “category”, which is determined by the asking-back category determination unit 12-1 and is not included in the original question from the user. The asked-back sentence-example (class) output unit 13-1 selects the “asked-back content” corresponding to the “category”, and outputs the selected data as an output from the case search apparatus 10B.

For example, in an asking-back operation for a question, “Power goes down spontaneously”, from a user, when an asking-back “category” of the “trouble occurrence trigger” is selected, it is determined that the asked-back content, “Please tell me what triggered the problem.”, for a “category” of the “trouble occurrence trigger” in the asked-back content table 13-1a is to be output. In addition, for example, in an asking-back operation for a question, “Unstable operation”, from a user, when an asking-back “category” of the “software” is selected, it is determined that the asked-back content, “If you are using some software, please tell me the name.”, for a “category” of the “software” in the asked-back content table 13-1a is to be output. In addition, for example, in an asking-back operation for a question, “Power will not be on”, from a user, when an asking-back “category” of the “OS” is selected, it is determined that the asked-back content, “Please tell me the name of the OS you are using.”, of a “category” of the “OS” in the asked-back content table 13-1a is to be output. The asked-back sentence-example (class) output unit 13-1 instructs the output unit 14 to output the determined asked-back content.

### A Labeling Process According to the Second Embodiment

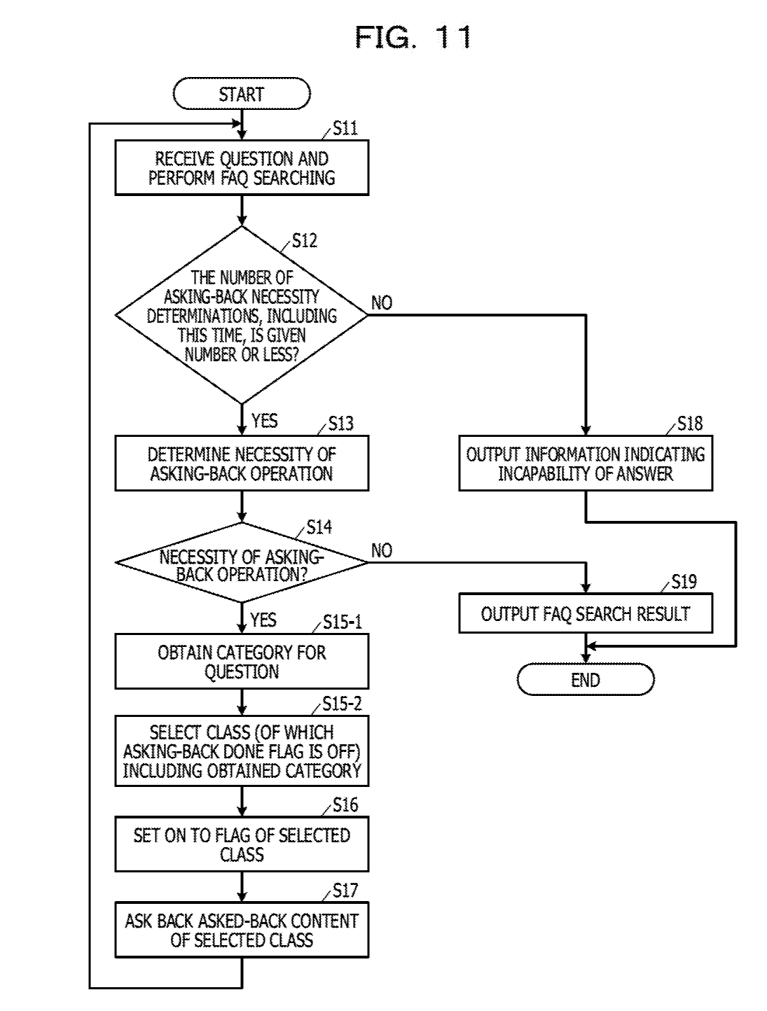

FIG. 11 is an exemplary flowchart of a labeling process according to the second embodiment. The label learning process according to the second embodiment is performed by the processing device of the case search apparatus 10B. Steps S11 to S14, steps S16 to S18, and step S19 in the label learning process according to the second embodiment are substantially the same as those in the label learning process according to the first embodiment.

If the result in step S14 indicates Yes, in step S15-1, the asking-back category determination unit 12-1 refers to the asking-back category learning model 12-1a to obtain a “category” for the negative example “question” received from the asking-back necessity determination unit 12. In step S15-2, the asked-back sentence-example (class) output unit 13-1 refers to the asked-back content table 13-1a to select a class (of which the asking-back done flag is OFF) including the category obtained in step S15-2. Upon completion of step S15-2, the asked-back sentence-example (class) output unit 13-1 performs step S16. Upon completion of step S18 or step S19, the case search apparatus 10B ends the asking-back necessity determination process according to the second embodiment.

In the second embodiment, for example, the search unit 11 receives question information. For example, the asking-back necessity determination unit 12 evaluates the received question information. The evaluation indicates an evaluation as to whether an asking-back operation is to be performed. In addition, for example the asking-back category determination unit 12-1, the asked-back sentence-example (class) output unit 13-1, and the output unit 14 determine, based on the evaluation result, which is to be performed between the following operations: an operation in which pieces of question information selected in accordance with the received question information from among the multiple pieces of question information stored in the storage unit are output in a selectable manner; and an operation in which information for prompting addition of information for specifying the received question information is output. The operation in which pieces of question information selected in accordance with the received question information from among the multiple pieces of question information are output in a selectable manner indicates an operation in which, for example, a given number of top FAQ search results for the received question information are displayed in a selectable manner.

According to the first and second embodiments described above, when information about a question from a user is insufficient, an appropriate question is asked back to the user, achieving improved accuracy in case searching.

### Other Embodiments

The first and second embodiments described above are not limiting. The case search apparatus 10A and the case search apparatus 10B may employ a first algorithm for obtaining, based on the scores, results through searching of the FAQ database 11a by the search unit 11, and may extract first question candidates (for example, a given number of top FAQ search results) selected in accordance with the received question information. Then, the case search apparatus 10A and the case search apparatus 10B may employ a second algorithm using a learning model that has learned the training data in which received question information is associated with the question ID of a correct answer (for example, FAQ), and may extract second question candidates selected in accordance with the received question information. When the extracted second question candidates (for example, a given number of question IDs corresponding to higher scores) are included in the extracted first question candidates, the case search apparatus 10A and the case search apparatus 10B may output, in a selectable manner, pieces of question information selected in accordance with the received question information. When the extracted second question candidates are not included in the extracted first question candidates, the case search apparatus 10A and the case search apparatus 10B may output information for prompting addition of information for specifying the received question information.

The components of the apparatuses illustrated in the first and second embodiments are conceptual in terms of the functions. The components are not necessarily configured physically as illustrated. That is, a specific state of distribution and integration of the apparatuses is not limited to the state as illustrated. All or some of the apparatuses may be functionally and physically distributed or integrated in any unit in accordance with various types of load and usage.

All or any of the processing functions performed by the processors may be implemented by using a CPU and a program analyzed and executed by the CPU, or may be implemented as hardware through wired logic.

A Case Search Program

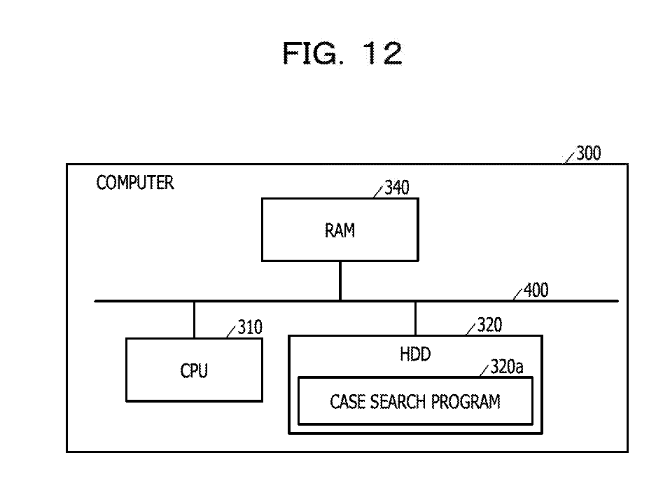

Various processes described in the first and second embodiments described above may be implemented by a computer system such as a server computer executing a program prepared in advance. An exemplary computer system executing a program having substantially the same functions as the first and second embodiments described above will be described below. FIG. 12 is a diagram illustrating a computer executing a case search program.

As illustrated in FIG. 12, a computer 300 includes a CPU 310, a hard disk drive (HDD) 320, and a random access memory (RAM) 340. The units 310 to 340 are connected to a bus 400.

The HDD 320 stores, in advance, a case search program 320a which exerts substantially the same functions as the processors in the above-described embodiments. For example, the case search program 320a which exerts substantially the same functions as the search unit 11, the asking-back necessity determination unit 12, the asked-back sentence-example (class) output unit 13, and the output unit 14 in the first embodiment described above is stored. Alternatively, the case search program 320a exerts substantially the same functions as the search unit 11, the asking-back necessity determination unit 12, the asking-back category determination unit 12-1, the asked-back sentence-example (class) output unit 13-1, and the output unit 14 in the second embodiment described above. For the case search program 320a, each function may be divided into modules appropriately.

The HDD 320 also stores various types of data. For example, the HDD 320 stores an OS and various data. The CPU 310 reads, for execution, the case search program 320a from the HDD 320. Thus, substantially the same operations as the processors in the first and second embodiments are performed. That is, the case search program 320a causes execution of substantially the same operations as the search unit 11, the asking-back necessity determination unit 12, the asked-back sentence-example (class) output unit 13, and the output unit 14 in the first embodiments. Alternatively, the case search program 320a causes execution of substantially the same operations as the search unit 11, the asking-back necessity determination unit 12, the asking-back category determination unit 12-1, the asked-back sentence-example (class) output unit 13-1, and the output unit 14 in the second embodiment.

The above-described case search program 320a is not necessarily stored in the HDD 320 from the beginning. For example, the program is stored in a “portable physical medium”, such as a flexible disk (FD), a compact disk read only memory (CD-ROM), a digital versatile disk (DVD), a magneto-optical disk, or an integrated circuit (IC) card, which is inserted into the computer 300. The computer 300 may read the program from the medium for execution.

The program is stored, for example, in a “different computer (or server)” connected to the computer 300 through a public line, the Internet, a local-area network (LAN), a wide-area network (WAN), and the like. The computer 300 may read the program from the different computer for execution.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A search apparatus comprising:
a memory; and
a processor coupled to the memory and the processor configured to:
receive question information,
perform evaluation of the question information, and
when a result of the evaluation satisfies a condition, output answer information extracted by searching based on the question information, the answer information being extracted from among a plurality of pieces of answer information stored in the memory, and, when the result of the evaluation does not satisfy the condition, output information for prompting input of additional information to specify detail of the question information.

2. The search apparatus according to claim 1,
wherein the evaluation of the question information is performed based on comparison between first answer information and second answer information, the first answer information being extracted by the searching based on a first algorithm, the second answer information being extracted by the searching based on a second algorithm, and
wherein the condition is that the second answer information is included in the first answer information.

3. The search apparatus according to claim 1, wherein the information for prompting the input is determined in accordance with an inverse document frequency value of a word, the word being not included in the question information.

4. The search apparatus according to claim 1, wherein the information for prompting the addition is determined in accordance with a category of the additional information, the additional information being such that the input of the additional information improves accuracy of answer information extracted by searching based on the additional information in a comparison with the answer information extracted by the searching based on the question information.

5. The s apparatus according to claim 1, the processor further configured to:
generate training data in such a manner that, when evaluation of the answer information is no less than a threshold, the answer information is determined to be a positive example as an answer to the question information, and that, when the evaluation of the answer information is less than the threshold, the answer information is determined to be a negative example an answer to the question information, and
learn, by using the training data, a first learning model for evaluating question information.

6. The search apparatus according to claim 1, the process further configured to:
generate training data in which a category of additional information is associated with the question information, the additional information being such that input of the additional information improves accuracy of searching, and
learn, by using the training data, a second learning model for determining additional information for prompting input.

7. The search apparatus according to claim 6, wherein the category of the additional information with which the evaluation is improved is determined in accordance with evaluation results of a plurality of pieces of answer information, the plurality of pieces of answer information being extracted by searching performed by adding, one by one, pieces of additional information to the question information, each of the pieces of additional information being included in different categories.

8. A search method executed by a computer, the method comprising:
receiving question information;
performing evaluation of the question information; and
when a result of the evaluation satisfies a condition, outputting answer information extracted by searching based on the question information, the answer information being extracted from among a plurality of pieces of answer information stored in the memory, and, when the result of the evaluation does not satisfy the condition, outputting information for prompting input of additional information to specify detail of the question information.

9. The search method according to claim 8,
wherein the evaluation of the question information is performed based on comparison between first answer information and second answer information, the first answer information being extracted by the searching based on a first algorithm, the second answer information being extracted by the searching based on a second algorithm, and
wherein the condition is that the second answer information is included in the first answer information.

10. The search method according to claim 8, wherein the information for prompting the input is determined in accordance with an inverse document frequency value of a word, the word being not included in the question information.

11. The search method according to claim 8, wherein the information for prompting the addition is determined in accordance with a category of the additional information, the additional information being such that the input of the additional information improves accuracy of answer information extracted by searching based on the additional information in a comparison with the answer, information extracted by the searching based on the question information.

12. The search method according to claim 8, further comprising:
generating training data in such a manner that, when evaluation of the answer information is no less than a threshold, the answer information is determined to be a positive example as an answer to the question information, and that, when the evaluation of the answer information is less than the threshold, the answer information is determined to be a negative example an answer to the question information; and
learning, by using the training data, a first learning model for evaluating question information.

13. The search method according to claim 8, further comprising:
generating training data in which a category of additional information is associated with the question information, the additional information being such that input of the additional information improves accuracy of searching; and
learning, by using the training data, a second learning model for determining additional information for prompting input.

14. The search method according to claim 13, wherein the category of the additional information with which the evaluation is improved is determined in accordance with evaluation results of a plurality of pieces of answer information, the plurality of pieces of answer information being extracted by searching performed by adding, one by one, pieces of additional information to the question information, each of the pieces of additional information being included in different categories.

15. A non-transitory computer-readable medium storing a search program that causes a computer to execute a process comprising:
receiving question information;
performing evaluation of the question information; and
when a result of the evaluation satisfies a condition, outputting answer information extracted by searching based on the question information, the answer information being extracted from among a plurality of pieces of answer information stored in the memory, and, when the result of the evaluation does not satisfy the condition, outputting information for prompting input of additional information to specify detail of the question information.
